(19) United States
(12) Patent Application Publication
(10) Pub. No.: US 2026/0171303 A1
(43) Pub. Date: Jun. 18, 2026

(54) COIL COMPONENT AND WIRELESS POWER TRANSMISSION DEVICE HAVING THE SAME

(71) Applicant: TDK CORPORATION, Tokyo (JP)

(72) Inventors: Michihisa TOKUI, Tokyo (JP); Sumin Kumar CHALISE, Tokyo (JP)

(73) Assignee: TDK CORPORATION, Tokyo (JP)

(21) Appl. No.: 19/415,903

(22) Filed: Dec. 11, 2025

(30) Foreign Application Priority Data
Dec. 13, 2024 (JP) 2024-218575

(51) Int. Cl. H01F 27/34; H01F 27/00; H01F 27/28; H02J 50/10; H02J 50/40

(52) U.S. Cl. CPC H01F 27/34; H01F 27/006; H01F 27/2823; H02J 50/10; H02J 50/402

(57) ABSTRACT

Disclosed herein is a coil component that includes a magnetic body having a plurality of areas located at different positions in a planar direction perpendicular to a thickness direction of the magnetic body, and first and second coils facing a surface of the magnetic body on one side in the thickness direction. The plurality of areas include a first area and a second area located outside the first area in the planar direction. The second area of the magnetic body has a smaller thickness in the thickness direction than the first area of the magnetic body. The first coil is disposed so as to overlap the first area of the magnetic body. The second coil is disposed so as to overlap the second area of the magnetic body.

### CROSS-REFERENCE TO RELATED APPLICATION

This application claims the benefit of Japanese Patent Application No. 2024-218575, filed on Dec. 13, 2024, the entire disclosure of which is incorporated by reference herein.

### BACKGROUND

The present disclosure relates to a coil component and a wireless power transmission device having the same.

A wireless power transmission device using a coil component has been known as a charging system for mobile devices such as smartphones. For example, JP 2018-153026A discloses a power transmission device having a plurality of power transmission coils conforming to different standards. This power transmission device includes magnetic bodies respectively assigned to the plurality of power transmission coils.

In recent years, attention has been focused on wireless power transmission devices conforming to both EPP (Extended Power Profile) and MPP (Magnetic Power Profile) standards. Such wireless power transmission devices are provided with an EPP-compliant first coil and an MPP-compliant second coil.

### SUMMARY

A coil component according to an embodiment of the present disclosure includes: a magnetic body having a plurality of areas located at different positions in a planar direction perpendicular to a thickness of the magnetic body; and first and second coils facing a surface of the magnetic body on one side in the thickness direction, wherein the plurality of areas include a first area and a second area located outside the first area in the planar direction, the second area of the magnetic body has a smaller thickness in the thickness direction than the first area of the magnetic body, the first coil is disposed so as to overlap the first area of the magnetic body, and the second coil is disposed so as to overlap the second area of the magnetic body. With this configuration, regardless of the case where the first coil is used or the case where the second coil is used, it is possible to reduce magnetic reluctance of the magnetic flux passing through the magnetic body. Further, since the second area of the magnetic body has a smaller thickness than the first area, a wider space can be provided above the second coil.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic cross-sectional view for explaining the structure of a coil component 1 according to an embodiment of the present disclosure;

FIG. 2 is a schematic plan view of the coil component 1 as seen from the coil axis direction thereof;

FIG. 3 is a plan view of the magnetic body 10;

FIG. 4 is a schematic cross-sectional view for explaining the structure of a coil component 1A according to a first modification;

FIG. 5 is a schematic cross-sectional view for explaining the structure of a coil component 1B according to a second modification;

FIG. 6 is a schematic view illustrating the electrical connection between the first and second coils 100 and 200;

FIG. 7 is an operation diagram of the coil component 1 illustrating the connection relation in the EPP mode;

FIG. 8 is an operation diagram of the coil component 1 illustrating the connection relation in the MPP mode;

FIG. 9 is a block diagram illustrating an example of the configuration of a wireless power transmission device 60 using the coil component 1.

### DETAILED DESCRIPTION OF THE EMBODIMENTS

The present disclosure describes a coil component capable of reducing magnetic loss more than conventional coil components.

Some embodiments of the present disclosure will be explained below in detail with reference to the accompanying drawings.

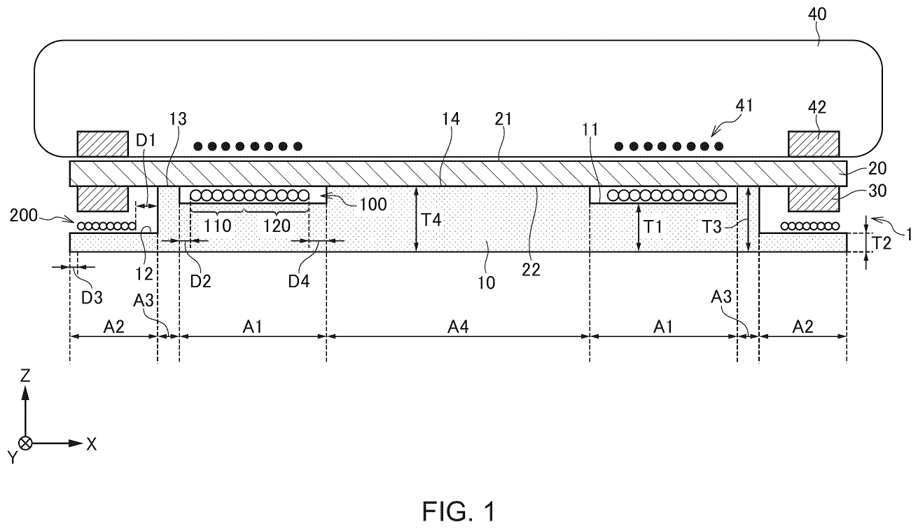

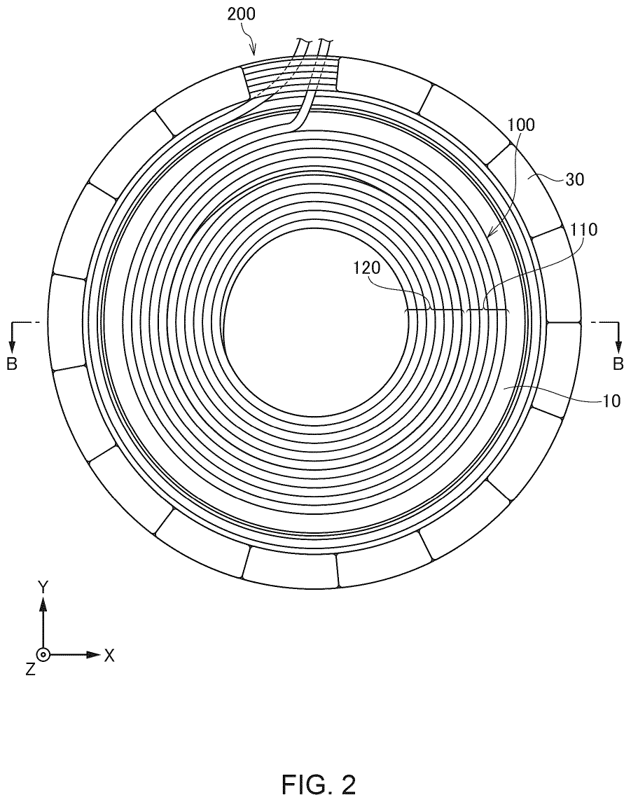

FIG. 1 is a schematic cross-sectional view for explaining the structure of a coil component 1 according to an embodiment of the present disclosure. FIG. 2 is a schematic plan view of the coil component 1 as seen from the coil axis direction thereof.

As illustrated in FIGS. 1 and 2, the coil component 1 according to the present embodiment includes a magnetic body 10 having a thickness in the Z-direction, first and second coils 100 and 200 overlapping the magnetic body 10 in the Z-direction, and a magnet module 30 fixed to a back surface 22 of a housing 20. A front surface 21 of the housing 20 serves as a placement surface on which an electronic device 40 (device to be charged) such as a smartphone is placed. For clarity of illustration, the housing 20 is omitted in the plan view of FIG. 2.

Both the first and second coils 100 and 200 function as power transmission coils for wireless power transmission. The first coil 100 is used for wireless power transmission in the MPP mode, while the second coil 200 is used for wireless power transmission in the EPP mode. As described later, a portion of the first coil 100 operates in the EPP mode together with the second coil 200. The EPP, one of the wireless charging standards, is capable of fast charging with a maximum output of 15W and enables wireless power transmission through bidirectional communication between a transmitting side and a receiving side. The MPP, one of the wireless charging standards, also known as a Qi2 standard, uses a magnet to perform accurate alignment of a power transmission coil and a power reception coil, thereby providing high power transmission efficiency and high usability.

The magnetic body 10 functions as a magnetic path for magnetic flux generated by the first and second coils 100 and 200. The magnetic body 10 may be formed of a bulk magnetic material, such as a ferrite sintered body. The specific permeability of the magnetic material constituting the magnetic body may be 30 or higher. This makes it possible to provide a high inductance value.

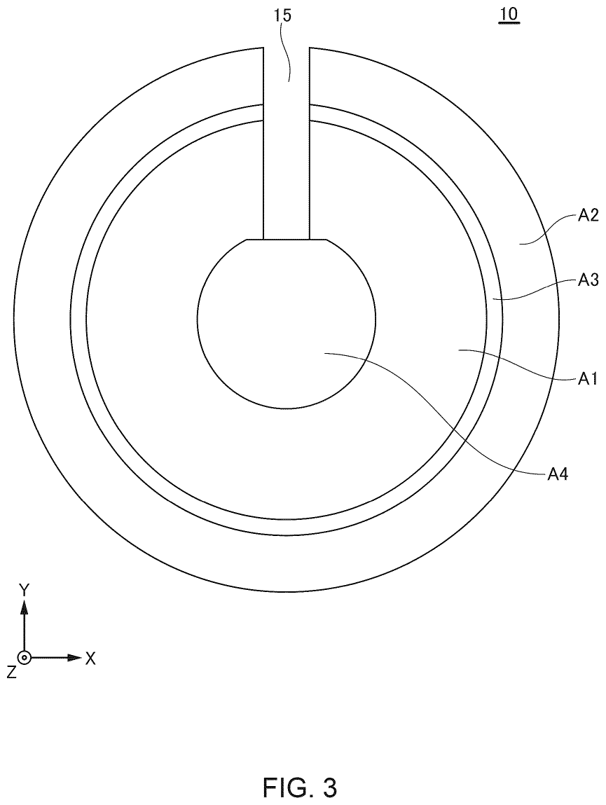

FIG. 3 is a plan view of the magnetic body 10.

As illustrated in FIGS. 1 to 3, the magnetic body 10 has first to fourth areas A1 to A4 at different positions in the XY plane direction perpendicular to the Z-direction as the thickness direction. The fourth area A4 is located at the center in the XY plane direction and has a circular shape partially cut in a plan view as seen from the Z-direction. The first area A1 is located outside the fourth area A4 in the XY plane direction so as to surround it and has an annular shape partially divided by a slit 15 in a plan view as seen from the Z-direction. The third area A3 is located outside the first and fourth areas A1 and A4 in the XY plane direction so as to surround them and has an annular shape partially divided by the slit 15 in a plan view as seen from the Z-direction. The second area A2 is located outside the third, first and fourth areas A3, A1, and A4 in the XY plane direction so as to surround them and has an annular shape partially divided by the slit 15 in a plan view as seen from the Z-direction. Although in the example illustrated in FIGS. 1 to 3, the second area A2 is the outermost area of the magnetic body 10, another area may be provided outside the second area A2. Further, although in the example illustrated in FIGS. 1 to 3, the fourth area A4 is the innermost area of the magnetic body 10, another area may be provided inside the fourth area A4. Furthermore, another area may be provided between two adjacent areas (e.g., first and fourth areas A1 and A4). Although in the present embodiment, the fourth area A4 has a circular shape partially cut in a plan view, it may have a partially cut elliptical shape or a partially cut polygonal shape. Further, although in the present embodiment, the first to third areas A1 to A3 have an annular shape partially divided by the slit 15 in a plan view, they may have an elliptical shape or a polygonal annular shape, which is partially divided by slit 15.

In the present embodiment, the first to fourth areas A1 to A4 included in the magnetic body 10 are not separate members but integral parts of the magnetic body 10. When the magnetic body 10 is made of a sintered body, for example, it is an integral sintered body including the first to fourth areas A1 to A4. That is, no physical boundary exists between the areas, and therefore the boundary portion between one area and another does not act as magnetic reluctance. In the present embodiment, the magnetic body 10 integrally formed is used, and the first and second coils 100 and 200 are disposed respectively on the first and second areas A1 and A2 of the magnetic body 10, thereby making it possible to prevent the magnetic path from being interrupted inside the magnetic body 10.

Assuming that the thicknesses of the first to fourth areas A1 to A4 in the Z-direction are T1 to T4, respectively, the following relations are satisfied: T1>T2, T3>T1, and T4 >T1. That is, the thickness of the second area A2 of the magnetic body 10 in the Z-direction is smaller than the thickness of the first area A1 of the magnetic body 10 in the Z-direction. The thickness T3 may be the same as the thickness T4. When the thickness T3 is the same as the thickness T4, a surface 13 of the third area A3 on one side (positive Z-direction side) in the thickness direction and a surface 14 of the fourth area A4 on one side (positive Z-direction side) in the thickness direction are in the same plane. The back surface of the magnetic body 10 on the other side (negative Z-direction side) may lie in the same plane across the first through fourth areas A1 to A4. The surface 13 of the third area A3 and the surface 14 of the fourth area A4 may be bonded to the back surface 22 of the housing 20. The height position of the upper surface of the first coil 100 from a surface 11 of the first area A1 of the magnetic body 10 on one side (positive Z-direction) in the thickness direction may be lower than the height position of the surface 13 of the third area A3 of the magnetic body 10. In other words, the surface of the third area A3 on the one side in the thickness direction may be located further on the one side in the thickness direction than the first coil 100. This makes it possible to prevent interference between the housing 20 and the first coil 100.

The first coil 100 is disposed on the surface 11 of the first area A1 of the magnetic body 10 so as to overlap the first area A1 in the Z-direction. As a result, the back surface of the first coil 100 is covered in the Z-direction by the first area A1 of the magnetic body 10, the innermost turn thereof is covered in the XY plane direction by the fourth area A4 of the magnetic body 10, and the outermost turn thereof is covered in the XY plane direction by the third area A3 of the magnetic body 10.

The second coil 200 is disposed on the surface 12 of the second area A2 of the magnetic body 10 on the one side (positive Z-direction side) in the thickness direction so as to overlap the second area A2 in the Z-direction. As a result, the back surface of the second coil 200 is covered in the Z-direction by the second area A2 of the magnetic body 10, and the innermost turn thereof is covered in the XY plane direction by the third area A3 of the magnetic body 10.

As described above, since the thickness T2 of the second area A2 of the magnetic body 10 in the Z-direction is smaller than the thickness T1 of the first area A1 of the magnetic body 10 in the Z-direction, the height position (position in the Z-direction) of the second coil 200 is lower than the height position (position in the Z-direction) of the first coil 100. As a result, a wider space is formed above (on the positive Z-direction side) the second coil 200 than the space above (on the positive Z-direction side) of the first coil 100. The magnet module 30 fixed to the back surface 22 of the housing 20 is disposed in the thus formed space above the second coil 200, thereby preventing interference between the second coil 200 and the magnet module 30.

Both the first and second coils 100 and 200 may be configured such that a covered wire, in which a conductive wire serving as a core is covered with an insulating coating such as a resin, is wound in a plurality of turns. This can reduce the resistance of the first and second coils 100 and 200 and facilitates design modifications regarding the number of turns, wire diameter, and the like. The wire diameter of the second coil 200 may be smaller than that of the first coil 100. This can prevent interference between the second coil 200 and the magnet module 30 and increase the number of turns of the second coil 200. Further, the resistance of the first coil 100 can be reduced by using a conductive wire with a greater diameter than that of the second coil 200. The first coil 100 may be a stranded wire including a plurality of core wires. This makes it possible to suppress an increase in AC resistance due to skin effect and proximity effect while ensuring a sufficient wire diameter. On the other hand, the second coil 200 may be a single wire including one core wire. This makes it possible to reduce resistance while suppressing an increase in the wire diameter. The first and second coils 100 and 200 may each be an FPC (Flexible Printed Circuit) coil, in which a coil pattern is formed on a flexible substrate, or a patterned coil, in which a coil pattern is formed using a conductive pattern on a substrate made of an insulating film such as PET (polyethylene terephthalate) or PI (polyimide).

The total thickness of the second coil 200 and the second area A2 of the magnetic body 10 in the Z-direction may be smaller than the thickness T1 of the first area A1 of the magnetic body 10. In other words, the height position of the upper surface of the second coil 200 from the surface 12 of the second area A2 of the magnetic body 10 may be lower than the height position of the surface 11 of the first area A1 of the magnetic body 10. In this case, in the Z-direction, the second coil 200 is located between the surface of the first area A1 of the magnetic body 10 on the positive Z-direction side and the surface of the second area A2 of the magnetic body 10 on the positive Z-direction side. This makes it possible to prevent interference between the second coil 200 and the magnet module 30 even when the magnet module 30 has a large thickness.

Assuming that the distance between the innermost turn of the second coil 200 and the third area A3 of the magnetic body 10 in the XY plane direction is D1 and that the distance between the outermost turn of the first coil 100 and the third area A3 of the magnetic body 10 in the XY plane direction is D2, D1 may be equal to or greater than D2. Further, assuming that the distance between the outermost turn of the second coil 200 and the outer peripheral edge of the magnetic body 10 in the XY plane direction is D3, D1 may be equal to or greater than D3. Furthermore, assuming that the distance between the innermost turn of the first coil 100 and the fourth area A4 of the magnetic body 10 in the XY plane direction is D4, D1 may be equal to or greater than D4. Thus, when the distance D1 is made equal to or greater than the distances D2 to D4, it is possible to suppress variations in the characteristics of the second coil 200. This is because the influence of the distance D1 on the characteristics of the second coil 200 is greater than the influence of the distances D2 and D4 on the characteristics of the first coil 100, and also greater than the influence of the distance D3 on the characteristics of the second coil 200.

As illustrated in FIG. 3, the magnetic body 10 may have the slit 15 extending in the Y-direction. The covered wires constituting the first and second coils 100 and 200 may be led out to the outside through the slit 15 formed in the magnetic body 10. This makes it possible to prevent interference between the covered wires led out from the first and second coils 100 and 200 and the magnetic body 10.

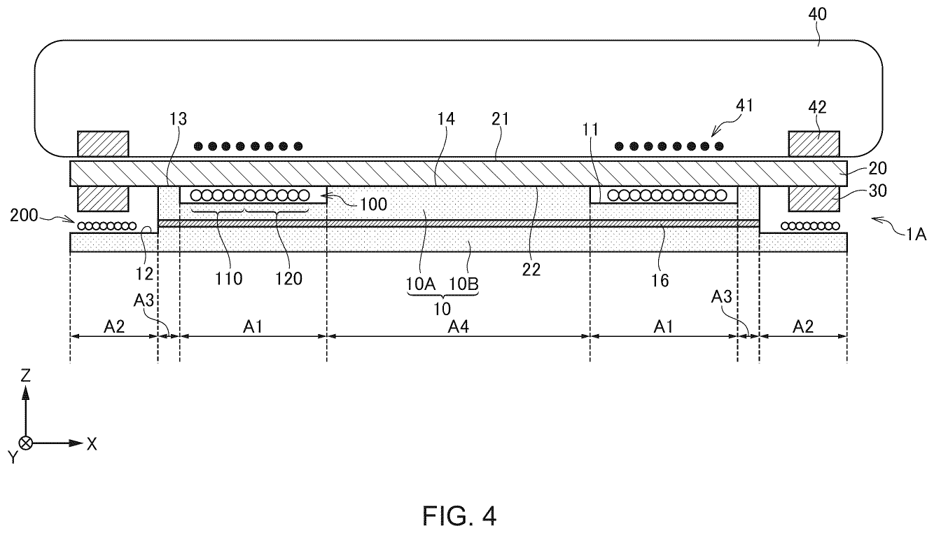

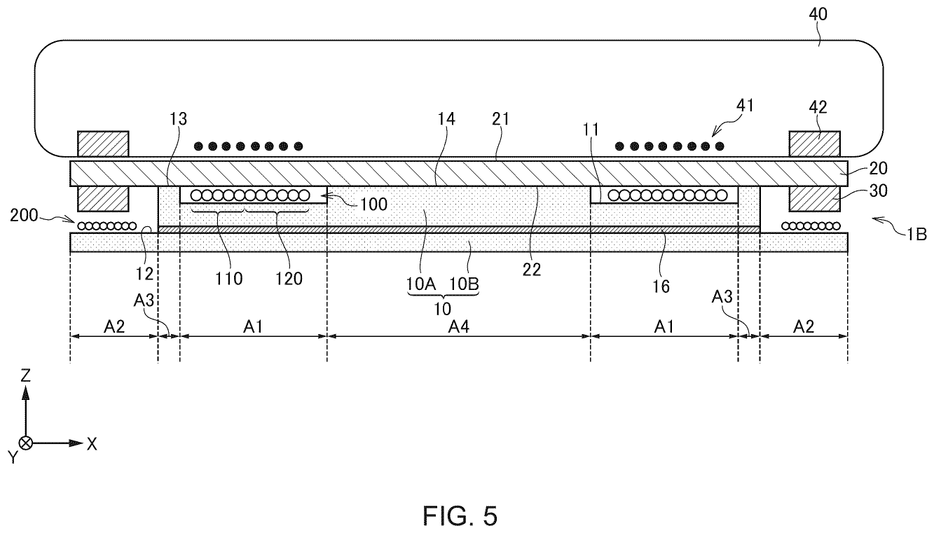

The magnetic body 10 may be composed of two magnetic bodies. For example, like coil components 1A and 1B according to a modification illustrated in FIGS. 4 and 5, a magnetic body 10A having the first coil 100 and a magnetic body 10B having the second coil 200 may be combined through an adhesive layer 16 to form the magnetic body 10. In the coil component 1A illustrated in FIG. 4, the magnetic body 10B having the second coil 200 has a protrusion at its center, and the magnetic body 10A having the first coil 100 is bonded to the protrusion through the adhesive layer 16. In the coil component 1B illustrated in FIG. 5, the magnetic body 10B having a flat-plate shape having the second coil 200 and the magnetic body 10A having the first coil 100 are bonded through the adhesive layer 16. Thus, the magnetic body 10A constituted by upper portions of the first area A1, the third area A3, and the fourth area A4 and the magnetic body 10B constituted by the entire second area A2 and lower potions of the first area A1, third area A3, and fourth area A4 may be combined to form the magnetic body 10. In this case, the magnetic body 10 having a complicated shape can be easily achieved. Further, in the structure illustrated in FIG. 5, the influence of changes in magnetic characteristics due to misalignment in bonding the magnetic bodies 10A and 10B can be suppressed. In the examples in FIGS. 4 and 5, the thickness of each of the first, third, and fourth areas A1, A3, and A4 is defined as the total thickness of the magnetic bodies 10A and 10B in the corresponding region, excluding the thickness of the adhesive layer 16.

The above is the structure of the coil component 1 according to the present embodiment. When the electronic device 40 such as smartphones is placed on the surface 21 of the housing 20 included in the thus configured coil component 1, the first coil 100 or the second coil 200 functioning as a power transmission coil and a power reception coil 41 included in the electronic device 40 are magnetically coupled to each other. As a result, power is wirelessly transmitted from the coil component 1 to the electronic device 40.

The magnet module 30 is annularly disposed on the back surface 22 of the housing 20 so as to overlap the second coil 200. The term “annularly” is not limited to a complete ring, and the magnet module 30 may be arranged in a partially removed state as illustrated in FIG. 2. The magnet module 30 acts to position the power reception coil 41 relative to the first and second coils 100 and 200 by means of the attractive force between the magnet module 30 and a magnet 42 provided on the electronic device 40. As described above, the second coil 200 partially overlaps the magnet module 30 as seen from the coil axis direction (Z-direction) of the second coil 200, while the second coil 200 and the magnet module 30 are disposed separately from each other as illustrated in FIG. 1.

One or more turns of the second coil 200, including the innermost turn, may be located inside the inner surface of the magnet module 30 as seen from the Z-direction. Thus, magnetic coupling between the second coil 200 and the power reception coil 41 can be established without complete blockage by the magnet module 30.

The first coil 100 includes, in combination, an outer peripheral part 110 formed by a predetermined number of turns on the outer peripheral side including its outermost turn and an inner peripheral part 120 formed by a predetermined number of turns on the inner peripheral side including its innermost turn. The number of turns in the outer peripheral part 110 may be smaller than that of the inner peripheral part 120. Even when the number of turns in the outer peripheral part 110 may be smaller than that of the inner peripheral part 120, the line length may be longer in the outer peripheral part 110 than in the inner peripheral part 120. The outer and inner peripheral parts 110 and 120 of the first coil 100 are not connected directly but through lead wires.

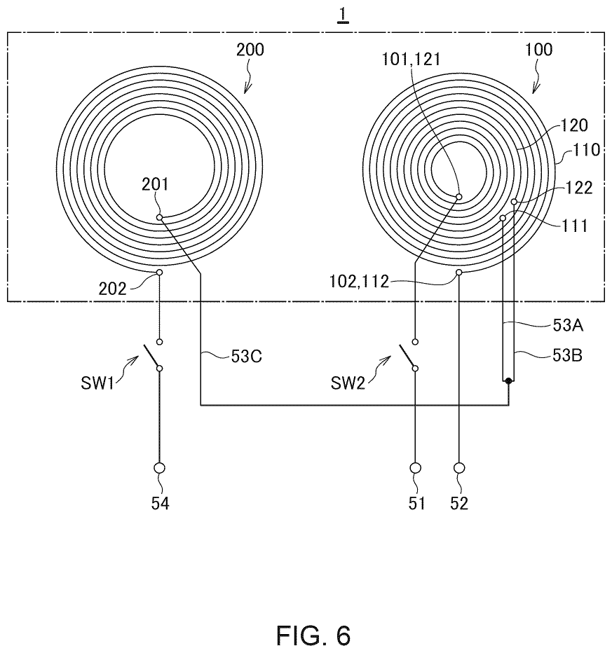

FIG. 6 is a schematic view illustrating the electrical connection between the first and second coils 100 and 200.

As illustrated in FIG. 6, the first coil 100 is wound counterclockwise from an outer peripheral end 102 toward an inner peripheral end 101, while the second coil 200 is wound clockwise from an outer peripheral end 202 toward an inner peripheral end 201. The outer peripheral end 102 of the first coil 100 is connected to a terminal 52. The outer peripheral end 202 of the second coil 200 is connected to a terminal 54 through a switch SW1. The first coil 100 includes the outer peripheral part 110 and the inner peripheral part 120 as described above. The inner peripheral end 111 of the outer peripheral part 110 and the outer peripheral end 122 of the inner peripheral part 120 are connected to lead wires 53A and 53B, respectively, and are led out to the outside of the winding portion of the first coil 100 through these lead wires. The inner peripheral end 101 of the first coil 100 is connected to a terminal 51 through a switch SW2. The inner peripheral end 201 of the second coil 200 is led out to the outside of the winding portion of the second coil 200 through a lead wire 53C and are connected respectively to the inner peripheral end 111 of the outer peripheral part 110 of the first coil 100 and the outer peripheral end 122 of the inner peripheral part 120 of the first coil 100.

The outer peripheral end 122 of the inner peripheral part 120 is adjacent to the inner peripheral end 111 of the outer peripheral part 110. Therefore, the apparent configuration of the first coil 100 is substantially the same as that of a single planar spiral coil formed by continuously winding a single conductive wire.

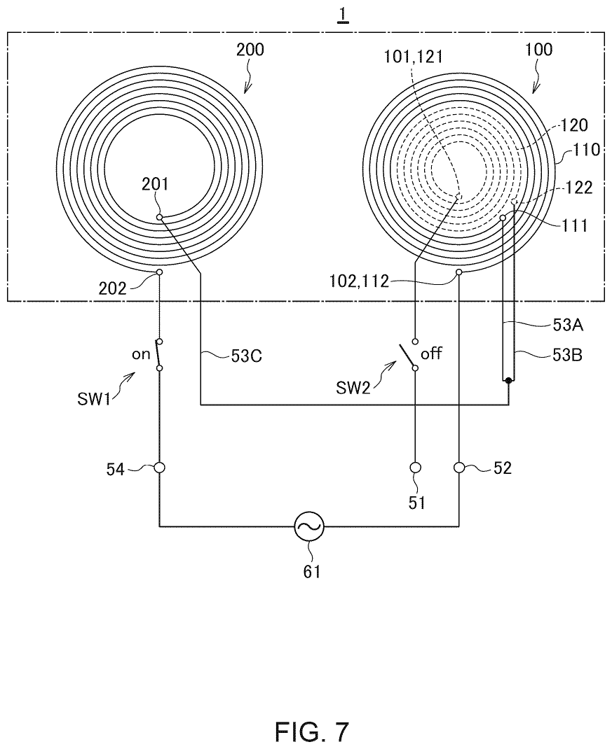

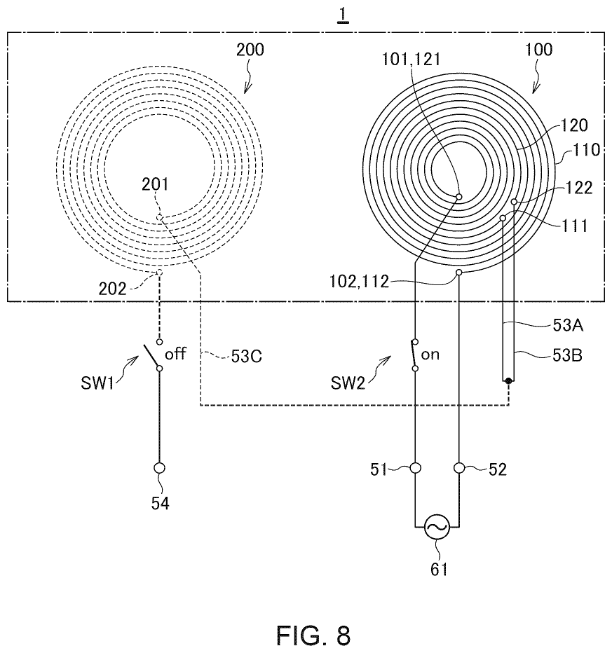

FIGS. 7 and 8 are operation diagrams of the coil component 1. Specifically, FIG. 7 illustrates the connection in the EPP mode, and FIG. 8 illustrates the connection in the MPP mode.

As illustrated in FIG. 7, when the coil component 1 operates in the EPP mode (first power transmission mode), the switch SW1 is turned ON, while the switch SW2 is turned OFF. As a result, the second coil 200 and the inner peripheral end 111 of the outer peripheral part 110 of the first coil 100 are connected in series to constitute one coil. When current flows from the outer peripheral end 202 of the second coil 200 toward the inner peripheral end 201 thereof, the current flows clockwise. When current flows from the inner peripheral end 111 of the outer peripheral part 110 toward the outer peripheral end 112 thereof, the current flows clockwise. Thus, the loop current directions of the second coil 200 and the outer peripheral part 110 of the first coil 100 can be made to coincide, allowing the outer peripheral part 110 to be used as a part of the second coil 200. That is, a combination of the outer peripheral part 110 of the first coil 100 and the second coil 200 forms one coil, and the outer peripheral part 110 of the first coil 100 functions as a part of an EPP coil. Transmission power is supplied from a power transmission circuit 61 to between the pair of terminals 52 and 54 of the MPP coil.

As illustrated in FIG. 8, when the coil component 1 operates in the MPP mode (second power transmission mode), the switch SW1 is turned OFF, while the switch SW2 is turned ON. As a result, the outer and inner peripheral parts 110 and 120 of the first coil 100 are connected in series. That is, a combination of the outer and inner peripheral parts 110 and 120 of the first coil 100 forms one coil, and the entire first coil 100 functions as an MPP coil. Transmission power is supplied from the power transmission circuit 61 to between the pair of terminals 51 and 52 of the EPP coil.

As described above, when the first and second coils 100 and 200 are wound in mutually opposite directions, the inner peripheral end 201 of the second coil 200 is connected to the inner peripheral end 111 of the outer peripheral part 110 and the outer peripheral end 122 of the inner peripheral part 120. Thus, only by inverting the ON/OFF states of the switch SW1 provided between the outer peripheral end 202 of the second coil 200 and the terminal 54 and the switch SW2 provided between the inner peripheral end 121 of the inner peripheral part 120 of the first coil 100 and the terminal 51, the two modes, MPP mode and EPP mode are available. That is, this can be achieved by connecting one of the pair of output terminals connected to the single power transmission circuit 61 to the terminal 52 and connecting the other one of the pair of output terminals to either the terminal 51 or 54 through selection by the switch, so that the number of switches can be reduced, and the selecting operation of these two modes can be easily achieved by using a multiplexer.

When power transmission is performed in the EPP mode, magnetic loss occurs due to the presence of the magnet module 30 in the power transmission direction of the second coil 200, which may reduce magnetic coupling with the power reception coil 41 included in the electronic device 40. However, in the present embodiment, the thickness T2 of the second area A2 of the magnetic body 10 in which the second coil 200 is disposed is smaller than the thickness T1 of the first area A1 of the magnetic body 10 in which the first coil 100 is disposed. This can provide a sufficient distance between the second coil 200 and the magnet module 30 in the Z-direction, thereby suppressing the reduction in magnetic coupling due to the presence of the magnet module 30. Further, by connecting the outer peripheral part 110 of the first coil 100, the entirety of which does not overlap the magnet module 30, to the second coil 200 so as to drive this part of the first coil 100 together with the second coil 200, the reduction in magnetic coupling due to the presence of the magnet module 30 can be suppressed. Further, when one or more turns of the second coil 200, including the innermost turn, are positioned inside the inner surface of the magnet module 30 as seen from the Z-direction, the reduction in magnetic coupling can be suppressed more effectively.

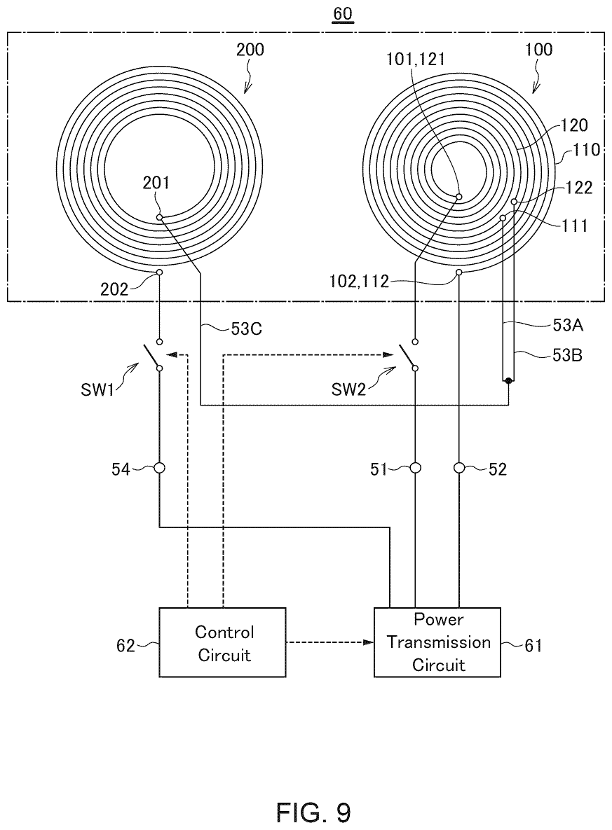

FIG. 9 is a block diagram illustrating an example of the configuration of a wireless power transmission device 60 using the coil component 1.

The wireless power transmission device 60 illustrated in FIG. 9 includes the coil component 1 having the first and second coils 100 and 200, the power transmission circuit 61 connected to the series circuit of the second coil 200 and the outer peripheral part 110 of the first coil 100 and the series circuit of the outer peripheral part 110 of the first coil 100 and the inner peripheral part 120 thereof, and a control circuit 62 configured to control the power transmission circuit 61 and the switches SW1 and SW2.

The wireless power transmission device 60 further includes the switches SW1 and SW2 for switching between power transmission modes. The switch SW1 (first switch) switches the connection state between the second coil 200 and the power transmission circuit 61. The switch SW2 (second switch) switches the connection state between the outer peripheral part 110 of the first coil 100 and the power transmission circuit 61. The switches SW1 and SW2 may each be a semiconductor switch mounted on a circuit board on which the power transmission circuit 61 and the control circuit 62 are mounted, or may each be part of the power transmission circuit 61 or the control circuit 62.

The control circuit 62 exclusively activates one of the switches SW1 and SW2 according to the target power transmission mode.

In the EPP mode, the switch SW is turned ON, while the switch SW2 is turned OFF to connect the series circuit of the second coil 200 and the outer peripheral part 110 of the first coil 100 to the power transmission circuit 61. In this state, power is supplied from the power transmission circuit 61, whereby the EPP mode power transmission using the second coil 200 and the part of the first coil 100 is performed.

In the MPP mode, the switch SW is turned OFF, while the switch SW2 is turned ON to connect the entire first coil 100 to the power transmission circuit 61. In this state, power is supplied from the power transmission circuit 61, whereby the MPP mode power transmission using the first coil 100 is performed.

As described above, the coil component 1 according to the present embodiment is configured such that the second area A2 has a smaller thickness in the Z-direction than the first area A1, so that even when the magnet module 30 is present above the second coil 200, physical interference between the second coil 200 and the magnet module 30 can be prevented, and a reduction in magnetic coupling due to the presence of the magnet module 30 can be suppressed.

While some embodiments of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

A coil component according to an embodiment of the present disclosure includes: a magnetic body having a plurality of areas located at different positions in a planar direction perpendicular to a thickness of the magnetic body; and first and second coils facing a surface of the magnetic body on one side in the thickness direction, wherein the plurality of areas include a first area and a second area located outside the first area in the planar direction, the second area of the magnetic body has a smaller thickness in the thickness direction than the first area of the magnetic body, the first coil is disposed so as to overlap the first area of the magnetic body, and the second coil is disposed so as to overlap the second area of the magnetic body. With this configuration, regardless of the case where the first coil is used or the case where the second coil is used, it is possible to reduce magnetic reluctance of the magnetic flux passing through the magnetic body. Further, since the second area of the magnetic body has a smaller thickness than the first area, a wider space can be provided above the second coil.

In the above-described coil component, the total thickness of the second coil and the second area of the magnetic body in the thickness direction may be smaller than the thickness of the first area of the magnetic body in the thickness direction. This makes it possible to provide a wider space above the second coil.

In the above-described coil component, a position of the second coil in the thickness direction may be located between the surface of the first area of the magnetic body on one side in the thickness direction and the surface of the second area of the magnetic body on one side in the thickness direction. This makes it possible to provide a wider space above the second coil.

In the above-described coil component, the magnetic body may further include a third area located between the first area and the second area, and the third area of the magnetic body may have a greater thickness in the thickness direction than the first area of the magnetic body. Thus, when a housing or the like is fixed on the surface of the third area, a space for accommodating the first coil can be provided above the first area.

In the above-described coil component, the distance between the innermost turn of the second coil and the third area of the magnetic body in the planar direction may be equal to or greater than the distance between the outermost turn of the first coil and the third area in the planar direction. This makes it possible to suppress variations in the characteristics of the second coil due to displacement thereof.

In the above-described coil component, the magnetic body may further include a fourth area located inside the first area in the planar direction, and the fourth area of the magnetic body may have a greater thickness in the thickness direction than the first area of the magnetic body. Thus, when a housing or the like is fixed on the surface of the fourth area, a space for accommodating the first coil can be provided above the first area.

In the above-described coil component, the distance between the innermost turn of the second coil and the third area of the magnetic body in the planar direction may be equal to or greater than the distance between the innermost turn of the first coil and the fourth area of the magnetic body in the planar direction. This makes it possible to suppress variations in the characteristics of the second coil due to displacement thereof.

In the above-described coil component, the surface of the third area on one side in the thickness direction may be located further on the one side in the thickness direction than the first coil. Thus, even when a housing or the like is fixed on the surface of the third area, interference between the first coil and the housing can be prevented.

In the above-described coil component, the magnetic body may be made of ferrite. This makes it possible to achieve high inductance.

In the above-described coil component, the first and second coils may each be formed by winding a conductive wire. This makes it possible to reduce the resistance of the first and second coils.

In the above-described coil component, the wire diameter of the second coil may be smaller than a wire diameter of the first coil. This makes it possible to form a wider space above the second coil and to increase the number of turns of the second coil.

In the above-described coil component, the first coil may have an outer peripheral part formed by a predetermined number of turns including the outermost turn and an inner peripheral part formed by a predetermined number of turns including the innermost turn, the winding directions of the first and second coils from the outer peripheral end to the inner peripheral end may be opposed, and the second coil may be connectable to the inner peripheral end of the outer peripheral part of the first coil. This makes it possible to reduce the number of switches, thereby enabling easy selection between two modes.

In the above-described coil component, the number of turns of the second coil may be greater than the number of turns of the inner peripheral part of the first coil and the number of turns of the outer peripheral part of the first coil. Thus, even when the second coil is displaced from a coil included in a device to be charged, a reduction in magnetic coupling can be suppressed.

The above coil component may further include an annularly disposed magnet module, and the second coil may have a portion that overlaps the magnet module as seen from the thickness direction. This makes it possible to properly position a device to be charged such as a smartphone in the planar direction.

In the above-described coil component, the second coil may have a portion that is located inside the inner surface of the magnet module as seen from the thickness direction. This makes it possible to suppress magnetic loss in the second coil due to the presence of the magnet module.

A coil component according to another embodiment of the present disclosure includes a coil and an annularly disposed magnet module, wherein the coil has a portion that overlaps the magnet module as seen from the axial direction of the coil, and the coil and the magnet module are disposed separately from each other. This makes it possible to suppress magnetic loss in the coil due to the presence of the magnet module.

A wireless power transmission device according to an embodiment of the present disclosure includes any one of the above-described coil components and a power transmission circuit connected to the coil component. This enables the wireless power transmission device to conform to a plurality of standards.

What is claimed is:

1. A coil component comprising:
a magnetic body having a plurality of areas located at different positions in a planar direction perpendicular to a thickness direction of the magnetic body; and
first and second coils facing a surface of the magnetic body on one side in the thickness direction,
wherein the plurality of areas include a first area and a second area located outside the first area in the planar direction,
wherein the second area of the magnetic body has a smaller thickness in the thickness direction than the first area of the magnetic body,
wherein the first coil is disposed so as to overlap the first area of the magnetic body, and
wherein the second coil is disposed so as to overlap the second area of the magnetic body.

2. The coil component as claimed in claim 1, wherein a total thickness of the second coil and the second area of the magnetic body in the thickness direction is smaller than a thickness of the first area of the magnetic body in the thickness direction.

3. The coil component as claimed in claim 1, wherein a position of the second coil in the thickness direction is located between a surface of the first area of the magnetic body on one side in the thickness direction and a surface of the second area of the magnetic body on one side in the thickness direction.

4. The coil component as claimed in claim 1,
wherein the magnetic body further includes a third area located between the first area and the second area, and
wherein the third area of the magnetic body has a greater thickness in the thickness direction than the first area of the magnetic body.

5. The coil component as claimed in claim 4, wherein a distance between an innermost turn of the second coil and the third area of the magnetic body in the planar direction is equal to or greater than a distance between an outermost turn of the first coil and the third area in the planar direction.

6. The coil component as claimed in claim 4,
wherein the magnetic body further includes a fourth area located inside the first area in the planar direction, and
wherein the fourth area of the magnetic body has a greater thickness in the thickness direction than the first area of the magnetic body.

7. The coil component as claimed in claim 6, wherein a distance between an innermost turn of the second coil and the third area of the magnetic body in the planar direction is equal to or greater than a distance between an innermost turn of the first coil and the fourth area of the magnetic body in the planar direction.

8. The coil component as claimed in claim 4, wherein a surface of the third area on one side in the thickness direction is located further on the one side in the thickness direction than the first coil.

9. The coil component as claimed in claim 1, wherein the magnetic body is made of ferrite.

10. The coil component as claimed in claim 1, wherein each of the first and second coils is formed by winding a conductive wire.

11. The coil component as claimed in claim 10, wherein a wire diameter of the second coil is smaller than a wire diameter of the first coil.

12. The coil component as claimed in claim 1,
wherein the first coil has an outer peripheral part formed by a predetermined number of turns including an outermost turn and an inner peripheral part formed by a predetermined number of turns including an innermost turn,
wherein winding directions of the first and second coils from an outer peripheral end to an inner peripheral end are opposed, and
wherein the second coil is connectable to an inner peripheral end of the outer peripheral part of the first coil.

13. The coil component as claimed in claim 12, wherein a number of turns of the second coil is greater than a number of turns of the inner peripheral part of the first coil and a number of turns of the outer peripheral part of the first coil.

14. The coil component as claimed in claim 1, further comprising an annularly disposed magnet module,
wherein the second coil has a portion that overlaps the magnet module as seen from the thickness direction.

15. The coil component as claimed in claim 14, wherein the second coil has a portion that is located inside an inner surface of the magnet module as seen from the thickness direction.

16. A coil component comprising:
a coil; and
an annularly disposed magnet module,
wherein the coil has a portion that overlaps the magnet module as seen from an axial direction of the coil, and
wherein the coil and the magnet module are disposed separately from each other.

17. A wireless power transmission device comprising:
a coil component as claimed in claim 1; and
a power transmission circuit connected to the coil component.
